(19) United States
(12) Patent Application Publication
(10) Pub. No.: US 2006/0048442 A1
(43) Pub. Date: Mar. 9, 2006

(54) Bye bye flys

(76) Inventor: Larry Leming, Burbank, CA (US)

Correspondence Address: Larry Leming, 215 S. Orchard Dr., Burbank, CA, 91506, US

(21) Appl. No.: 10/934,968

(22) Filed: Sep. 7, 2004

(51) Int. Cl. A01M 1/24

(52) U.S. Cl. 43/119

(57) ABSTRACT

A device that attracts, and subsequently allows flies, and other flying insects, to exit from an enclosed area, such as rooms in a house or commercial building. This device is not a trap, nor does it exterminate flying insects. Rather it enables flying insects to return to the outside environment alive. The device is comprised of a single, unobtrusive, clear, plastic material attachment to a corner of a screen or window. There is a funnel-like hole or tube in the center of the device that is punched through the screen and allows flying insects to “escape” an enclosed area. At the outer portion of the tube there are converging pointed tabs that prevent flying insects to enter or return to the enclosed area. This invention is attached to a window screen by barbed prongs that grab the screen and holds this device firmly in place.

### FIELD OF THE INVENTION

This device relates to the reduction or elimination of flying insects from enclosed spaces, e.g. rooms, warehouses, patios, and porches. This invention, however, is not a trap, nor does it utilize insecticides, or other means to kill flying insects. It is a device that controls the population of flying insects trapped within an enclosed space by attracting them, and then providing a means for them to exit the enclosed space.

### DISCUSSION OF PRIOR ART

There are no patented devices that attract flying insects, and then allow them to exit an enclosed space. There a many patented insecticides used to exterminate flying insects. There are a myriad of inventions that are traps mounted on or near a window or screen, that trap insects, and then kill them with insecticides. All of the inventions in this field are traps of one kind or another. For example, the following patents utilize the trap and kill method for reducing or eliminating flying insects from an enclosed space: U.S. Pat. No. 4,044,494 to Grajnert; U.S. Pat. No. 5,239,771 to Beardsley; U.S. Pat. No. 2,629,628 to Vaillancourt; U.S. Pat. No. 2,350,519 to Olson; U.S. Pat. No. 2,042,236 to Moye; U.S. Pat. No. 1,951,289 to Menze; and U.S. Pat. No. 1,870,712 to Crown.

The Grajnert trap is a housing that claims to attract flying insects by reflecting light into a chamber, and then trapping and/or killing them. The object of the invention is to trap, and prevent escape, ie. The flying insects remain in the enclosed space inside the trap. Similarly, the Beardsley invention is a housing that purports to more effectively prevent flies from escaping by trapping them, albeit at a lower cost to manufacture than the Grajnert trap. The Vaillancourt invention repels insects from the outside of a door or window. The Olson device is a fly trap suspended outside a door or window screen to prevent entrance of flying insects by repelling or killing them. The Moye, Menze, and Crown inventions are traps mounted on window or door screens, both outside and inside, designed to trap and ultimately kill flies. Some of these traps' do not address the problem of flying insects who do find their way into an enclosed area. In all these prior inventions the trapped flying insects remain in the trap, either dead or dying, until the trap is manually cleaned out. Unlike the present invention, not one of these inventions simply attracts flying insects to a device on a window or door screen and then provides an exit so that the flying insects will escape the confined space to the outside environment. This invention is simple, and inexpensive to produce. It is not an unsightly and cumbersome trap with their multiple cones, wires, baffles, entry chambers, hoods, and other contraptions designed to trap and warehouse flying insects. It does not involve the use of poisons, nor require manual emptying or cleaning.

### OBJECTS AND ADVANTAGES OF THE PRESENT INVENTION

The principal object of this invention is to effectively reduce or eliminate any flying insects trapped in an interior, enclosed, space such as a room, patio/porch, warehouse, or virtually any building that has windows and screens, by releasing the flying insects through this device into the outside environment. It is designed to attach to the corner of a window or door screen. It is a single, clear, thin, plastic device with glittering particles embedded in the plastic material that serves to attract flying insects that are naturally attracted to the light outside the window screen. This device is installed expeditiously. A small slit or hole is made in the corner of the screen to accommodate the funnel-like, tapered cone that extends just beyond the outside of the screen. Four barbed prongs that are part of the plastic device fit easily through the screen mesh, and the barbs latch around the screen, holding it firmly in place.

This invention is inexpensive to produce. It effectively avoids the need for exposing residents, including children and pets, to toxic pesticides in the home. It reduces the presence of unsightly, bacteria carrying, insect carcasses scattered on window sills, on the floor after being “swatted”, or caught in traps. It provides a means for flying objects to exit the home, rather than exposing a resident to the irritating buzzing that accompanies flying insects attempting to escape an enclosed area. It is unobtrusive, and not an unsightly trap contraption mounted in the middle of a screen.

### BRIEF DESCRIPTION OF THE DRAWINGS

FIG. 1 is a perspective view of the invention as it appears from the inside of an enclosed area.

FIG. 2 is a perspective view of the invention as it appears from the outside of an enclosed area.

FIG. 3 is a cross sectional view of the invention indicated by the section lines 3-3 FIG. 4.

FIG. 4 is a view of the invention form its side that faces to the outside of an enclosed area.

FIG. 5 is a view of a window/door screen that illustrates a typical location for installation of the invention.

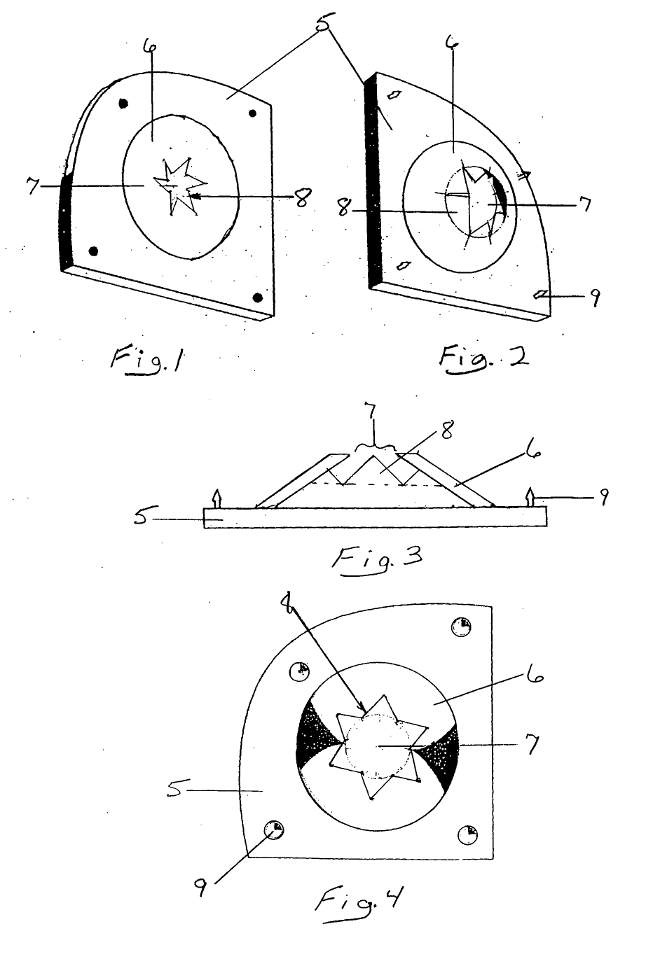

### REFERENCE NUMERALS IN DRAWINGS FIG. 1

5 single piece transparent plastic attachment
6 funnel-like open cone projection
7 opening in device that provides an exit
8 pointed converging tabs
9 barbed mounting prongs
10 window with screen
11 invention attached to screen

### DESCRIPTION OF THE INVENTION

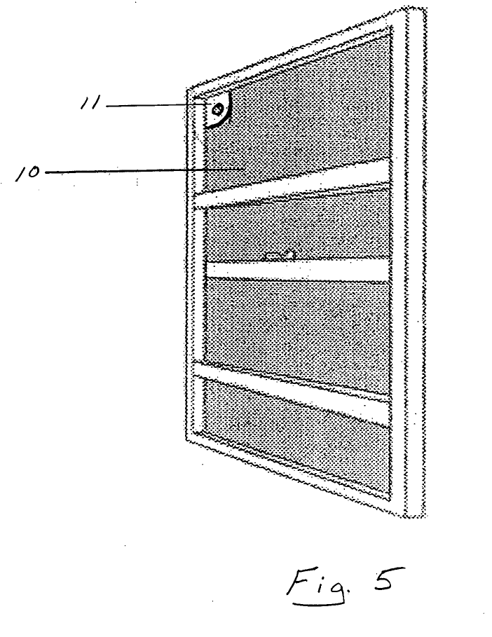

With reference to the drawings, FIG. 1 through FIG. 4 are various views of the present invention. FIG. 4 is a view of the device showing the opening 7 that flying insects will be attracted to, and subsequently exit an enclosed space through the invention. The invention is attached to a window/door screen as in FIG. 5. The opening 7 is shown in perspective in FIG. 1 and FIG. 2 at the end of funnel-like cone 6 that extends to the outside of the window/door screen. FIG. 3 gives a cross sectional view the opening 7, the funnel-like cone 6, and converging pointed tabs 8 that illustrates the path, from bottom of FIG. 3 toward the top of FIG. 3 that flying insects will take to exit an enclosed area. FIG. 1 through FIG. 4 offer different views of the pointed converging tabs 8 that allow flying insects to escape but are designed to prevent flying insects to enter the enclosed area. When flying insects arrive at the opening in the invention they are able to freely exit due to the shape of the funnel-like cone 6, but they are unable to fly past the pointed converging tabs 8. The pointed converging tabs 8, and the funnel-like cone 6 project outside of the enclosed area though a small hole or slit in the screen. This hole in the screen may be easily created by e.g. pushing a pencil point through the screen.

Once the invention's funnel-like cone 6 penetrates the hole in the screen, the four barbed mounting prongs 9 penetrate between the screen mesh, and hook around the outside of the screen mesh, holding the invention securely to the screen. The entire invention is a single piece of extruded transparent plastic material 1 with reflective particles embedded in the plastic. This invention is unobtrusive, FIG. 5, and inexpensive to produce. Its size is less than 3 square centimeters.

### OPERATION OF INVENTION

Flying insects are naturally attracted to light. They continually congregate on window/door screens searching for an escape. This invention simply further attracts the flying insects, and provides them with an escape into the outside environment, while preventing other flying insects from entering the same enclosed area from outside through the invention.

I claim:

1. A device for controlling the population of flying insects, within an enclosed area in a building that does not trap or kill, but attracts and then allows flying insects to exit the space, said device comprising:
a. a single, thin, transparent, plastic device that mounts in the corner of a window, or door, screen that has a funnel-like, conical hole in the center of the device that is large enough to allow flying insects to exit the enclosed area, and outwardly directed pointed tabs that converge toward the center of the hole thus preventing flying insects to enter the enclosed area from the outside;
b. said device composed of a plastic material impregnated with a “sparkling” material that reflects and refracts light that in turn attracts flying insects to this exit device;
c. and is secured to a window screen, after a small hole is cut in the screen, by four small prongs with barbed tips that hook through and grab the screen mesh.
